(19) United States
(12) Patent Application Publication
(10) Pub. No.: US 2006/0202175 A1
(43) Pub. Date: Sep. 14, 2006

(54) Flame retarding system for nylon fabrics

(76) Inventor: Charles Q. Yang, Athens, GA (US)

Correspondence Address: GREENLEE WINNER AND SULLIVAN P C, 4875 PEARL EAST CIRCLE, SUITE 200, BOULDER, CO, 80301, US

(21) Appl. No.: 11/373,495

(22) Filed: Mar. 10, 2006

Related U.S. Application Data
(60) Provisional application No. 60/660,405, filed on Mar. 10, 2005.

(51) Int. Cl. C09K 21/00

(52) U.S. Cl. 252/601

(57) ABSTRACT

Provided is a flame retardant system for nylon fabric comprising: (a) an organophosphorus oligomer having two terminal hydroxy groups; (b) a bonding system; and (c) one or more catalysts. The organophosphorous oligomer has the formula: 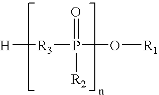
where R3 is independently selected from the group consisting of: —O— and 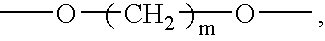 where m is an integer from 1 to 6; n is an integer from 1 to 10; R1 is H or a hydroxyalkyl group with from 1 to 6 carbon atoms; and R2 is independently selected from the group consisting of: alkyl, alkoxy and hydroxyalkoxy with from 1 to 6 carbon atoms. The bonding system is selected from the group consisting of: (a) a condensation product of melamine and formaldehyde having at least 2 hemiacetal groups; (b) dimethyloldihydroxyethyleneurea (DMDHEU); (c) a mixture of DMDHEU and condensation product of melamine and formaldehyde with 2-6 hemiacetal groups from formaldehyde in its molecule; and (d) a polycarboxylic acid with at least three carboxyl groups in adjacent carbons of the back bone. Nylon fabrics treated with the provided flame retarding system are durable to home laundering.

### CROSS-REFERENCE TO RELATED APPLICATIONS

This application claims priority from U.S. provisional application Ser. No. 60/660,405, filed Mar. 10, 2005, which is hereby incorporated by reference in its entirety.

### BACKGROUND OF THE INVENTION

It is difficult to impart durable flame retardancy to nylon and nylon-containing fabrics due to the low reactivity of nylon and poor penetration of a finishing solution into the fiber. Although aramid fibers, such as Kevlar and Nomex, are inherently flame resistant, the high cost of those aramid fibers has limited their wide application. In recent years, flame retardant finishing of nylon and nylon-cotton blend fabrics has drawn strong interest because those fabrics are widely used to produce protective clothing in the military as well as civilian sectors.

Several review articles on attempts to prepare flame retardant nylon have been published [1-5]. Two approaches have been attempted. The first approach is to use flame retardant additives including organophosphorus and halogenated aliphatic/aromatic compounds at the fiber spinning stage [1-4]. However, the amount of the additives required to achieve the flame retardancy may be high enough to cause significant reduction in fiber strength, and technical difficulties are often encountered during the spinning operations [1,3]. The second approach is to apply flame retardant finishes to nylon fabrics after spinning. A number of flame retardant finishing systems, such as thiourea derivatives, ammonium sulfamate and organophosphorus compounds, have been reported [4-10], but none of those technologies has achieved substantial commercial success.

The flame retardant finishing of a blend fabric containing cotton and a thermoplastic synthetic fiber such as nylon and polyester is difficult because of the “scaffolding effect” of the blend [2-3]. A number of patents disclose the use of the tetrakis(hydroxymethyl)phosphonium and urea precondensate to treat cotton/nylon blend fabrics, but those flame retardant finishing systems have not been commercialized [11-16]. The nylon/cotton (50/50) blend twill fabric, known as Battledress Uniform (BDU) fabric used to make military uniforms in the U.S., is currently not flame retardant finished in spite of the urgent need of flame resistant treatment for this fabric.

A flame retardant system for nylon and nylon-containing fabrics is needed.

### SUMMARY OF THE INVENTION

Provided is a flame retardant system for nylon fabric. The flame retardant finishing system comprises: (a) an organophosphorus oligomer having two terminal hydroxy groups; (b) a bonding system; and (c) one or more optional catalysts.

The organophosphorous oligomer having two terminal hydroxy groups has the general formula: 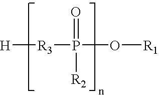
where R3 is independently selected from the group consisting of: —O— and 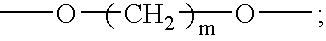
m is an integer from 1 to 6; n is an integer from 1 to 10; R1 is H or a hydroxyalkyl group with from 1 to 6 carbon atoms; and R2 is independently selected from the group consisting of: alkyl, alkoxy and hydroxyalkoxy groups with from 1 to 6 carbon atoms.

In one specific embodiment, the organophosphorous oligomer has the formula: 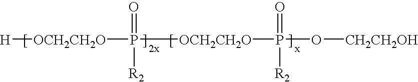
where x is a positive integer and R2 is as defined above. In one specific embodiment the oligomer having two terminal hydroxy groups is shown above where R2 is independently methoxyl or methyl, and which oligomer contains approximately 20% phosphorus.

In one specific embodiment, the organophosphorous oligomer has the formula: 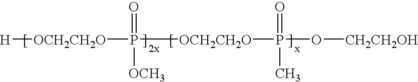
where x is a positive integer.

In one embodiment, the organophosphorous oligomer is CA Register No. 70715-06-9.

The amount of the organophosphorous oligomer having two terminal hydroxy groups used in the flame retarding composition is from about 5-50% of the weight of fabric (wof) based on 100% solid, preferably 10-40% wof depending on the fabrics to be treated. The amount of the organophosphorous oligomer having two terminal hydroxy groups used in the flame retarding composition is easily determinable by one of ordinary skill in the art without undue experimentation.

The catalyst is selected from the group consisting of: MgCl₂; a mixture of MgCl₂ and citric acid (for example, 10:1 to 20:1 w/w); NH₄Cl; phosphoric acid; phosphorous acid; and hypophosphorus acid; or a mixture of the catalysts listed above. The amount of catalyst used is easily determinable by one of ordinary skill in the art. In general, 0.1 to 1% by weight of the bonding system is used.

The fabric to which the flame retarding composition is applied is selected from the group consisting of: nylon-6; nylon-6,6; a blend of cotton (10-90%) and nylon-6 or -6,6 (90-10%); preferably cotton (35-65%) and nylon (65-35%) and aramid-blend fabrics, including Nomex and Nomex/cotton in various proportions, as known in the art, including 63/35 Nomex/cotton. One class of nylon fabric are those nylon fabrics which do not include cotton or other cellulosic materials.

The bonding system for the flame retarding system is selected from the group consisting of:
(a) a condensation product of melamine and formaldehyde having at least 2 hemiacetal groups from formaldehyde, such as trimethylol melamine (TMM, shown in Scheme I) or the melamine-formaldehyde condensation product with functionality of 4.5 (at least 4.5 hemiacetal groups from formaldehyde) (XMM), or their mixture; 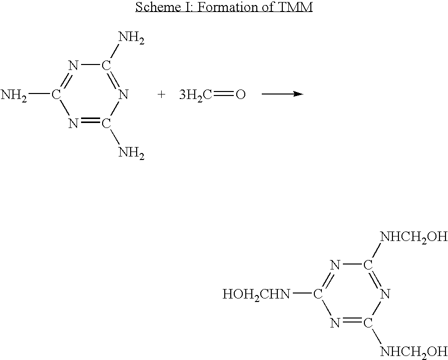
(b) Dimethyloldihydroxyethyleneurea (DMDHEU, shown in Scheme II); 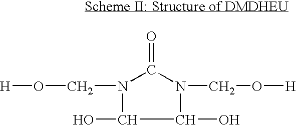
(c) a mixture of DMDHEU and condensation product of melamine and formaldehyde with 2-6 hemiacetal groups from formaldehyde in its molecule; and
(d) a polycarboxylic acid having at least three carboxyl groups in adjacent carbons of the molecular backbone. Particular examples are: 1,2,3,4-butanetetracarboxylic acid (BTCA), or a mixture of polycarboxylic acids.

The total amount of the bonding system used is between about 0.1 to about 15% wof. In a particular embodiment, the amount of melamine-formaldehyde condensation products used is between about 1-10 weight-of-fabric (wof) based on 100% solid, preferably 3-6% wof. In a particular embodiment, the amount of DMDHEU or its derivatives is 0.5-10 (wof) based on 100% solid, preferably 2-8% wof. In a particular embodiment, the amount of polycarboxylic acids used is 2-1 5(wof) based on 100% solid, preferably 6-8% wof. The use of DMDHEU, TMM and multifunctional carboxylic acids are described in references 17-21 listed below.

The composition is an aqueous solution. In one embodiment, the composition is applied to fabrics by a pad-dry-cure method, as known in the art. In one example, the curing temperature is between about 130-190° C., preferably 150-170° C. for an amount of time to provide the desired amount of treatment, for example, between about 1-10 minutes. Other curing temperatures and time are known in the art.

Also provided is a flame retardant system for Nomex/cotton blend fabric comprising: (a) an organophosphorus oligomer having two terminal hydroxy groups; (b) a polycarboxylic acid with at least three carboxyl groups in adjacent carbons of the back bone; and (c) one or more optional catalysts.

Also provided is a method of treating nylon fabric comprising:
applying a composition comprising: (a) an organophosphorus oligomer having two terminal hydroxy groups; (b) a bonding system; and (c) one or more catalysts to a nylon fabric.

Also provided is nylon fabric treated with the flame retardant systems described herein.

### BRIEF DESCRIPTION OF THE FIGURES

FIG. 1 shows TG curves of the untreated nylon-6,6 fabric and that treated with 40% FR, 6% DMDHEU and 6% TMM, and cured at 165° C. for 2 min.

FIG. 2 shows DTG curves of the untreated nylon-6,6 fabric and that treated with 40% FR 6% DMDHEU and 6% TMM, and cured at 165° C. for 2 min.

FIG. 3 shows DSC curves of the untreated nylon-6,6 fabric and that treated with 40% FR 6% DMDHEU and 6% TMM, and cured at 165° C. for 2 min.

FIG. 4 shows the phosphorus concentration of the nylon/cotton (50/50) blend fabric treated with 40% FR in combination with DMDHEU/TMM and with TMM/XMM as a function of the number of home laundering cycles.

FIG. 5 shows the LOI (%) of the nylon/cotton (50/50) blend fabric treated with 40% FR in combination with DMDHEUITMM and with TMM/XMM as a function of the number of home laundering cycles.

FIG. 6 shows the percent phosphorus retention of the nylon/cotton (50/50) blend fabric treated with FR and different melamine-formaldehyde bonding agents as a function of the number of home laundering cycles.

FIG. 7 shows the phosphorus retention (after 1, 10, 25, and 50 laundering cycles) of the cotton fabric treated with 32% FR and the combination of DMDHEU and M-F and cured at 165° C. for 2.5 min.

FIG. 8 shows the correlations between the LOI and the ratios of DMDHEU/(DMDHEU+M-F) and M-F/(DMDHEU+M-F) of the cotton fabric treated with 32% FR and the combination of DMDHEU and M-F at different ratios and cured at 165° C. for 2.5 min (before wash).

FIG. 9 shows the correlations between LOI and the ratios of DMDHEU/(DMDHEU+M-F) and M-F/(DMDHEU+M-F) of the cotton fabric treated with 32% FR and the combination of DMDHEU and M-F at different ratios and cured at 165° C. for 2.5 min (after 25 laundering cycles).

FIG. 10 shows the correlations between the tensile strength at the filling direction and the ratios of DMDHEU/(DMDHEU+M-F) and M-F/(DMDHEU+M-F) of the cotton fabric treated with 32% FR and the combination of DMDHEU and M-F at different ratios and cured at 165° C. for 2.5 min.

FIG. 11 shows the phosphorus content of the cotton fabric treated with 7% binders with a DMDHEU/(DMDHEU+M-F) ratio of 0.29 (2/7) in combination with FR at different concentrations (before wash, after 1,10, 25, and 50 laundering cycles).

FIG. 12 shows the percent phosphorus retention of the cotton fabric treated with 7% (DMDHEU+M-F) with a DMDHEU/(DMDHEU+M-F) ratio of 0.29 (2/7) in combination with FR at different concentrations (after 1, 10, 25, and 50 laundering cycles).

FIG. 13 shows the LOI of the cotton fabric treated with 7% (DMDHEU+M-F) with a DMDHEU/(DMDHEU+M-F) ratio of 0.29 (2/7) in combination with FR at different concentrations (before wash, after 1, 10, 25, and 50 laundering cycles).

FIG. 14 shows the tensile strength of the cotton fabric treated with 7% (DMDHEU+M-F) with a DMDHEU/(DMDHEU+M-F) ratio of 0.29 (2/7) in combination with FR at different concentrations.

### DETAILED DESCRIPTION OF THE INVENTION

The invention is further described in the following non-limiting description and examples. Applicant does not wish to be bound by any theory presented here.

### EXAMPLE 1

### (1) 100% Nylon-6 Knit Fabric: (2)100% Nylon-6,6 Woven Fabric; and (3) 50/50 Nylon/Cotton BDU Printed Fabric

Materials

Three fabrics were used in this study: (1) 100% nylon-6 knit fabric (Tesffabrics Style 304) weighing 73 g/m²; (2) 100% nylon-6,6 woven fabric (Tesffabrics Style 306A) weighing 59 g/m²; and (3) 50/50 nylon/cotton BDU printed fabric weighing 216g/m². FR (“Fyroltex HP”) is a commercial product with near 100% solid supplied by Akzo Nobel Phosphorus Chemical Division, Dobbs Ferry, N.Y. DMDHEU is a commercial product (44% solid content) with the trade name of “Freeaz 900” supplied by Noveon, Cleveland, Ohio. Two melamine-formaldehyde resins were used in this study: (1) TMM, a commercial product (80% solid content) with the trade names of “Aerotex M-3”, and (2) XMM, a commercial product of melamine-formaldehyde having the functionality of 4-5 (85% solid content) with the trade name of “Aerotex 3730”. The two melamine-formaldehyde resins were supplied by Noveon, Cleveland, Ohio. The catalyst was an NH₄Cl-based commercial product with the trade name of “Catalyst RD” supplied by Eastern Color & Chemical, Greenville, S.C.

Fabric Treatment and Home Laundering Procedures

The fabric was first immersed in a finish solution containing FR, the bonding system and the catalyst, then passed through a laboratory padder with two dips and two nips, dried at 90° C. for 3 min, and finally cured in a Mathis curing oven at a specified temperature. All concentrations presented in this study are based on weight of bath (w/w, %) and concentrations of FR, DMDHEU and TMM are based on 100% solid. The wet pick-up of the cotton/nylon fabric is approximately 75%. The wet pick-up of the nylon-6,6 woven fabric is approximately 60% and the wet pick-up of the nylon-6 knit fabric is approximately 150%. After curing, the treated fabric was subjected to a number of home laundering washing/drying (HLWD) cycles with the use of “MTCC standard detergent 1993”. The HLWD process was done according to MTCC Test Method 124-1996 (“Appearance of Fabrics After Repeated Home Laundering”). The water temperature of laundering was approximately 46° C.

Evaluation of the Flame Retarding Performance of the Fabrics

The vertical flammability of the cotton fabric is measured according to ASTM Standard Method D6413-99. The limiting oxygen index (LOI) of the cotton fabric is measured according to ASTM Standard Method D2863-97.

Determination of Phosphorus Concentration on the Treated Fabric

Approximately 2 g of the treated cotton fabric taken from three different parts of a 10 inch by 12 inch fabric specimen were ground in a Wiley mill into a powder to improve sample uniformity. 2 ml of concentrated H₂SO₄ was added to 0.1 g of cotton powder in a beaker. 10 ml of 30% H₂O₂ was added dropwise to the mixture, allowing the reaction to subside between drops. The reaction mixture was then heated at approximately 250° C. to digest the powder and to evaporate the water until dense SO₃ vapor was produced. The completely digested cotton sample as a clear solution was transferred to a 50-ml volumetric flask, then diluted with distilled/deionized water. The sample thus prepared was analyzed with a Thermo-Farrell-Ash Model 965 inductively coupled plasma atomic emission spectrometer (ICP/AES) to determine the % concentration of phosphorus. The percent phosphorus retention was calculated by dividing the phosphorus content of the fabric after laundering by that of the fabric before laundering.

Thermal Analysis

A Mettler Toledo TGA 851 and Mettler Toledo DSC 821 were used for thermal gravimetry (TG) and differential scanning calorimetry (DSC) measurements. All samples were heated from 50° C. at a rate of 10° C./min with a continuous air flow at a rate of 30ml/min. The sample weight was approximately 6 mg.

Results and Discussion

The nylon-6,6 fabric was treated with 40% FR, in combination with 6% DMDHEU and 6% TMM, dried at 90° C. for 3 min, and cured at 165° C. for 2 min. The fabric thus treated was subjected to 3 home laundering cycles. The phosphorus concentration on the treated nylon fabric before laundering was 3.63%, and it became 1.52% after one laundering cycle and remained statistically unchanged after three laundering cycles (Table 1). One observes that 41% of the FR applied to the nylon fabric remained on the fabric after three laundering cycles.

The nylon-6 fabric was treated with 40% FR, 6% DMDHEU and 6% TMM, and cured at 165° C. for 2 min. The amount of FR initially applied to the nylon-6 fabric was significantly higher than that applied to the nylon-6,6 fabric as a result of higher wet pick-up due to the loose structure of the knit fabric. After the treated nylon-6 fabric was subjected to three home laundering cycles, however, the percent retention of phosphorus (42%) on the nylon-6 fabric was very close to that on the treated nylon-6,6 fabric (41%). It should also be pointed out that the amount of phosphorus on the treated nylon fabric show almost no reduction as the number of home laundering cycles increase from 1 to 3 (Tables 1 and 2). Thus, the data presented here clearly indicate that the flame retardant organophosphorus oligomer on the nylon fabrics was durable to home launderings after the curing process.

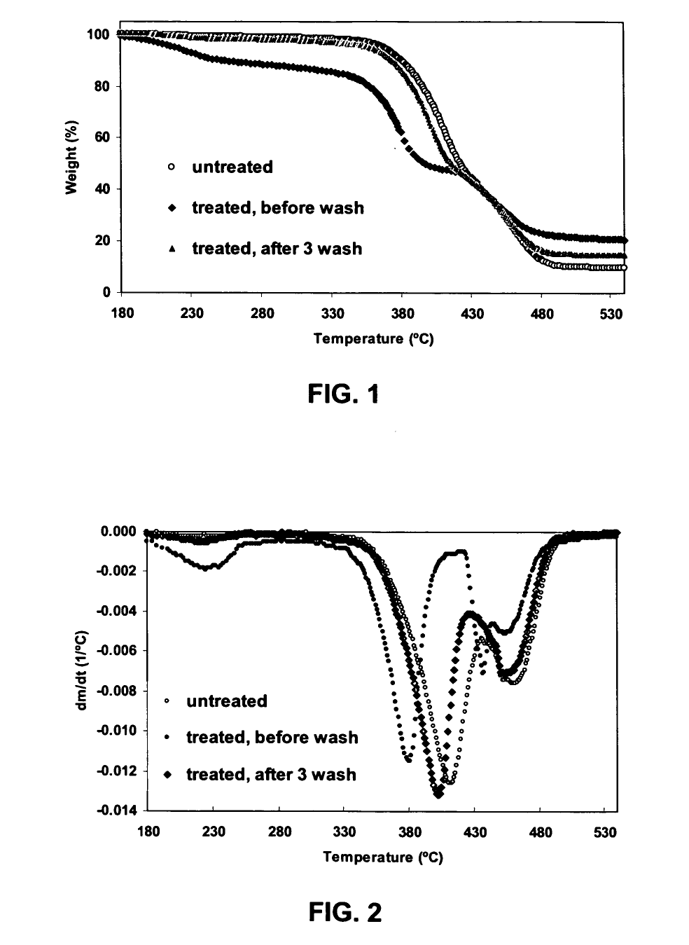

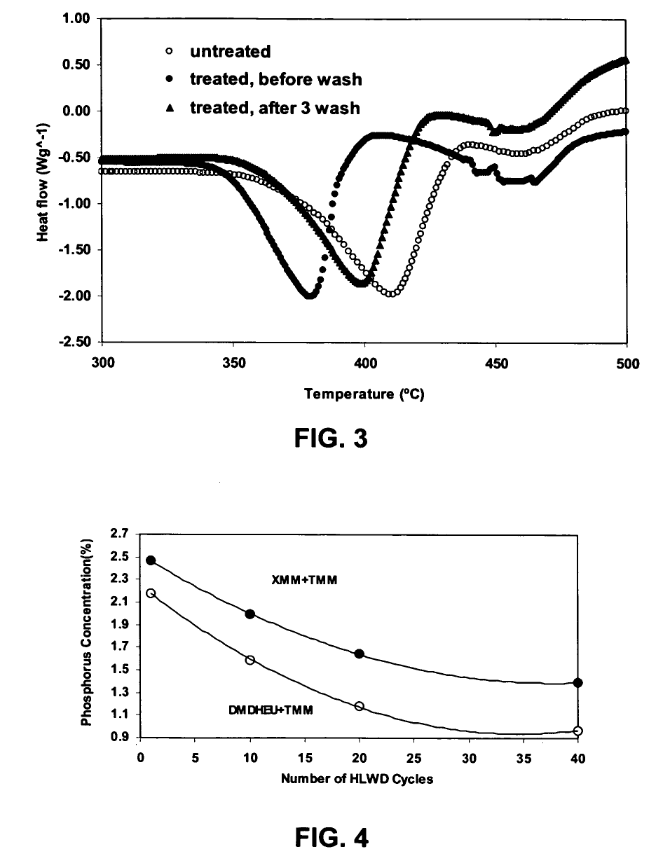

Thermal analysis techniques (TG and DSC) were applied to study the nylon-6,6 and nylon-6 fabrics treated with FR/DMDHEU/TMM described above. The TG, differential thermogravimetric (DTG) and DCS curves of the treated nylon-6,6 fabric measured in air atmosphere are presented in FIGS. 1, 2 and 3, respectively. The untreated nylon-6,6 fabric started to lose weight at 360° C. (FIG. 1). The rate of weight loss reached its maximum at 412° C. as indicated by the peak in the DTG curve (FIG. 2). The weight loss of the untreated nylon fabric was attributed to the thermal decomposition of nylon-6,6, which caused the main chain breakdown with the formation of NH₃, H₂O, CO, CO₂ and hydrocarbons [22-23]. The decomposition of nylon in this temperature range is confirmed by the endothermal peak at 412° C. in the DSC curve of the nylon-6,6 fabric (FIG. 3). The untreated nylon-6,6 lost 90% of its original weight with 10% residual solid at 500° C. (FIG. 1).

After the nylon-6,6 fabric was treated with FR and before it underwent home laundering, the rate of weight loss of the fabric thus treated reaches its maximum at 379° C. as a result of the presence of FR on the nylon fabric (FIG. 2), and the DSC curve of the fabric also shows an endothermal peak at 379° C. (FIG. 3). The treated fabric lost 79% of its original weight as the temperature was increased to 500° C. with 21% solid residual (FIG. 1). The data presented indicate that the presence of the organophosphorus oligomer on the nylon fabric lowered the decomposition temperature and it increased the amount of solid residual (char) after the decomposition was complete.

The TG, DTG and DSC curves of the nylon-6,6 fabric treated with FR and subjected to three cycles of home laundering are also presented in FIGS. 1, 2 and 3, respectively. The DTG and the DSC curves show the decomposition peak at 398° C., which is still lower than that of the untreated nylon (412° C.). The TG curve reveals that the nylon-6,6 fabric lost 83% of its original weight at 500° C. with 17% solid residual (FIG. 1).

The data presented here demonstrate that the FR on the treated nylon-6,6 fabric reduced the decomposition temperature and increased the amount of solid residual during the TG/DSC experiment. The effects of the FR-based finishing system on the thermal properties of the nylon-6 fabric were also studied using the thermal analysis techniques. The nylon-6 fabric was also treated with 40% FR, 6% DMDHEU and 6% TMM, and cured at 165° C. for 2 min. The TG, DTG and DSC data are summarized in Table 3. One observes similar phenomenon that the decomposition temperature was reduced and the solid residual after thermal exposure was increased for the fabric treated and subjected to three laundering cycles. Thus, the thermal analysis data of both the treated nylon-6,6 and the treated nylon-6 fabrics confirm that the organophosphorus oligomer applied to the nylon fabrics were retained on the fabrics after home laundering.

The fact that a significant portion of the FR applied to the two different nylon fabrics was retained after multiple laundering indicates that the FR applied to the nylon fabric was durable to home laundering after the curing process. The bonding of FR to the nylon fiber may be attributed to the reactions of the bonding agents (DMDHEU or TMM) with both FR and nylon. Those bonding agents have multiple hemiacetal groups in their molecules to react with hydroxyl groups of FR and the terminal amine groups of the nylon, thus forming “bridges” between FR and the nylon fibers. The typical concentration of the terminal amine group of nylon-6,6 is 40 μmole/g (Horrocks A R, Zhang S., Char formation in polyamide (nylon 6 and nylon 6.6) and wool keratin phosphorylated by polyol chlorides. Textile Res. J 2004; 74:433). The laundering durability of the FR on the nylon fabrics is mainly attributed to the crosslinking of the FR/TMM system. It was found that TMM (a trifunctional hemiacetal) reacted with FR (a bifunctional alcohol) to form a crosslinked polymeric network, shown in Scheme IIII, as the TMM concentration relative to that of FR is increased [20]. The organophosphorus oligomer (FR) became a part of the crosslinked polymeric network, which were bound to cotton through multiple acetal linkages between TMM and cotton. Consequently, the laundering durability of the FR on the cotton/nylon was significantly improved.

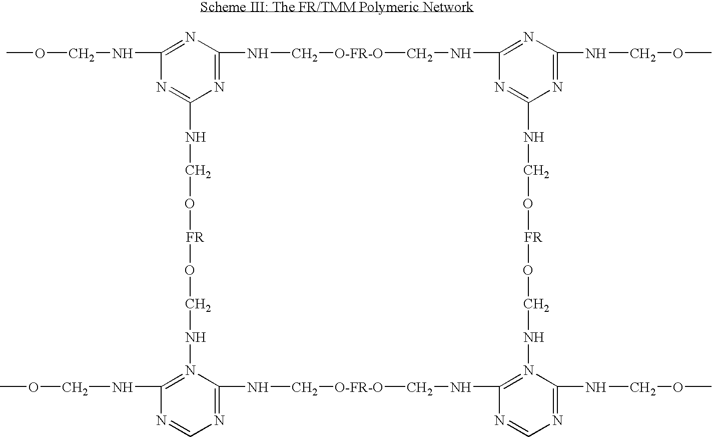

It is believed that DMDHEU largely functions as a bifunctional reagent and reacts with FR to form a linear condensation product.

Cotton/nylon BDU fabric was treated with 40% FR in combination with DMDHEU/TMM and with XMM/TMM, as shown in Table 4, cured at 165° C. for 2 min, and subjected to different number of home laundering cycles. The phosphorus concentration of the fabric thus treated is shown in FIG. 4. The phosphorus concentration on the fabric treated using DMDHEU/TMM and XMM/TMM were 3.93 and 3.89%, respectively, before laundering. It decreased to 2.47% (63% retention) for the fabric treated with FR/TMM/XMM after one laundering cycle, whereas it became 2.18% (55% retention) for that treated with FR/DMDHEU/TMM. After 20 laundering cycles, the phosphorus concentration decreased to 1.65 (42% retention) and 1.18% (30% retention) for the fabric treated with XMM/TMM and DMDHEU/TMM as the bonding system, respectively (FIG. 4).

The two formulas contained the same concentration of FR and TMM. The only difference was the second bonding agent in the formula. The fabric treated with DMDHEU as the second component in the bonding system shows significantly lower phosphorus concentration throughout the 40 laundering cycles than that treated with XMM (FIG. 4). One also observes that the difference in phosphorus concentration between those two treated fabric samples increases as the number of laundering cycle increases (FIG. 4).

The different effectiveness between XMM and DMDHEU in the bonding system is probably related to the ability of the bonding system to form crosslinked networks on the fabric with FR. DMDHEU forms linear structures with FR, as discussed previously. Since XMM has a higher functionality than TMM, it has higher reactivity towards FR to form a crosslinked network than TMM. The higher laundering durability of the fabric treated using TMM/XMM as the bonding system can be attributed to the increased amount of the crosslinked network formed on the fabric. Fabric treated with XMM/TMM show higher stiffness than that treated with DMDHEU/TMM, which is an indication that the amount of the crosslinked network was increased on the cotton/nylon blend as the DMDHEU was replaced by XMM in the formula.

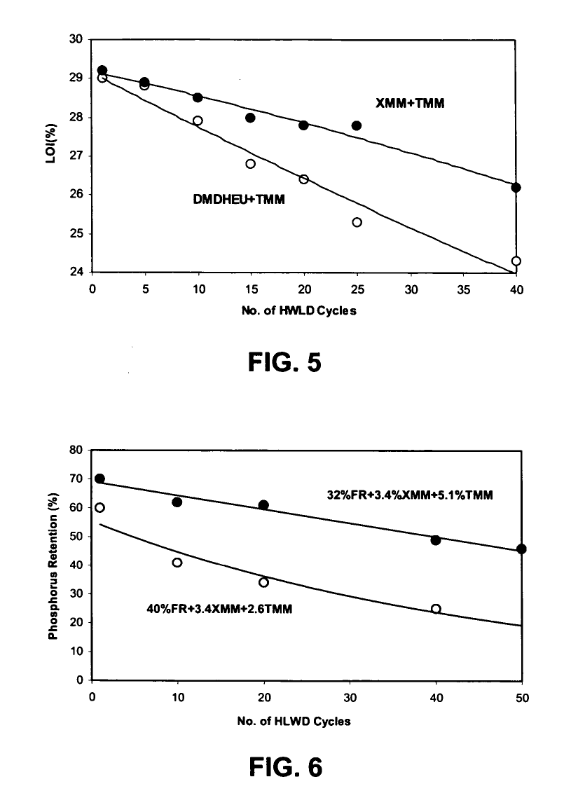

The LOI of the cotton/nylon fabric treated with the two formulas is plotted against the number of laundering cycles in FIG. 5. One observes that as the number of laundering cycle increased, the LOI of the fabric treated with XMM/TMM became significantly higher than that treated with DMDHEU/TMM (FIG. 5), thus confirming that the fabric treated with XMM/TMM had higher laundering durability than that treated with DMDHEU/TMM. The difference in LOI between those two treated fabric samples becomes greater as the number of laundering cycle increases (FIG. 5).

The char length for the vertical burning test is shown in Table 5. The char formation of the fabric treated with two formulas appears to be similar. After 50 laundering cycles, the char length for both treated fabric samples was still under 10 cm (Table 5). Thus, the cotton/nylon fabric treated with the FR-based finish system demonstrates high levels of flame retardant performance and laundering durability.

The performance of the FR-based flame retardant finishing system was also investigated using different concentrations of FR, TMM and XMM. Two different formulas contained FR at two concentration levels (32 and 40%), 4% XMM, and TMM at two concentration levels (5.1 and 2.6%) (Table 6). The treated fabric was cured at 1650 for 2 min. The phosphorus content of the fabric treated with 40% FR, 3.4% XMM and 2.6% TMM (Sample B1) is compared with that treated with 32% FR, 3.4% XMM and 5.1% TMM (Sample B2) in Table 7, and the percent phosphorus retention of the fabric samples thus treated is plotted against the number of home laundering cycle in FIG. 6. The initial phosphorus concentration for fabric Sample B1 (3.79%) was significantly higher than that of Sample B2 (3.09%), because Sample B1 was treated with 40% FR whereas Sample B2 was treated with 32% FR (Table 6). After one laundering cycle, Sample B2 showed higher phosphorus retention (70%) than that of Sample B1 (60%) even though its phosphorus concentration (2.17%) was slightly lower than that of Sample B1 (2.26%). When the number of the home laundering increased to 10, the phosphorus concentration of Sample B2 (1.91%) becomes notably higher than that of Sample B1 (1.55%) with corresponding phosphorus retention at 62 and 41%, respectively. The difference in percent phosphorus retention for the two treated fabric samples became more profound as the number of laundering cycle increased. After 20 laundering cycles, Sample B2 showed 61% retention of the applied FR whereas Sample B1 had only 34% retention (FIG. 6). Thus, the data indicate that the combination of 3.4% XMM and 5.1% TMM as the bonding system provided significantly higher retention of the FR on the fabric as well as improved laundering durability.

The LOI and char length of the two treated fabric samples are presented in Tables 8 and 9. Fabric Sample B2 had LOI (29.5%) than that of Sample B1 (29.3%) before wash even though its phosphorus content (3.09%) was lower than that of Sample B1 (3.79%). This was because the TMM concentration for Sample B2 (5.1%) is significantly higher that that of Sample B1 (2.6%), since both TMM and XMM functions as nitrogen providers to enhance the flame retarding performance by means of phosphorus-nitrogen synergism [18-20]. During the entire 50 laundering cycles, Sample B2 had higher LOI than Sample B1 , as shown in Table 8, in spite of the lower FR concentration in its formula. Fabric Sample B2 passed the vertical flammability test with a char length of 9.6 cm after 40 laundering cycles while Sample B1 failed the test (Table 9). Therefore, the fabric treated with 32% FR, 3.4% XMM and 5.1% TMM demonstrated notably better flame retarding performance and laundering durability than that treated with 40% FR, 3.4% XMM and 2.6% TMM.

The FR applied to the nylon-6,6 and nylon-6 fabrics became durable to home laundering when a bonding system including DMDHEU and TMM was present. The laundering durability of FR is attributed to the formation of a FR/TMM crosslinked polymeric network on the nylon fabrics. The cotton/nylon BDU fabric treated with the combination of DMDHEU and TMM and with the combination of TMM and XMM shows high levels of flame retarding performance and laundering durability. The selection of the bonding system and the bonding system-to-FR weight ratio in a finish formulation are the two important parameters for achieving high levels of flame retarding performance.

### EXAMPLE 2

### Nomex/Cotton Blend Fabric

FR in combination with BTCA as the binder to treat the Nomex/cotton (65/30) blend fabric was tested. The Nomex/cotton fabric was treated with FR and BTCA in combination with H₃PO₂ (catalyst) and triethylamine (TEA) (additive) at different concentration levels, and cured at 1 65° C. for 2 min. The LOI and char length of the fabric thus treated is presented in Tables 10 and 11, respectively. The concentration of FR ranged from 12 to 24% whereas the concentration of BTCA increased from 4 to 8% (⅓ of that of FR) accordingly. The Nomex/cotton had LOI of 21,8 and failed the fabric vertical flammability test, showing that the blend did not have flame resistance without the chemical treatment (Tables 10 and 1 1). When FR was applied to the fabric at a relatively low concentration (12%), the treated fabric passed the fabric vertical flammability test with char length of 67 mm after 20 laundering cycles (Table 11). When the FR concentration was increased to 24%, the treated fabric showed LOI of 30,3 and char length of 40 mm after 20 laundering cycles (Tables 10 and 11). Thus, the data presented here demonstrate that the Nomex/cotton fabric has good flame resistance at low finish add-on levels.

### EXAMPLE 3

### Statistical Analysis of dimethyloldihydroxyethyleneurea (DMDHEU) and Melamine-Formaldehyde (TMM) System

Materials

The fabric used was a desized, scoured, and bleached 40×40 cotton printcloth weighing 108 g/m² (Testfabrics Style 400). The hydroxy-functional organophosphorus oligomer with the commercial name of “Fyroltex HP” was supplied by Akzo Nobel Functional Chemicals, Dobbs Ferry, N.Y. DMDHEU with the commercial name of “Freerez 900” and trimethylolated melamine (TMM) with the commercial name of “Aerotex M-3” were supplied by Noveon, Cleveland, Ohio. In this example, the term “M-F” is also used to designate TMM. The catalyst based on NH₄Cl with the commercial name of “Catalyst RD” was supplied by Eastern Color & Chemical, Greenville, S.C.

Fabric Treatment and Home Laundering Procedures

The fabric was first immersed in a finish solution containing FR, mixture of DMDHEU and TMM, and the catalyst, then passed through a laboratory padder with two dips and two nips, dried at 90° C. for 3 min, and finally cured in a Mathis curing oven at 165° C. for 2.5 min. The weight of the catalyst (commercial product) in all formulas was 0.07% of that of (DMDHEU+TMM). All other concentrations (w/w, %) presented here were calculated based on weight of reagent (solid) and that of the bath. The wet pick-up of the cotton fabric was approximately 105±3%. After curing, the treated cotton fabric was subjected to different numbers of home laundering cycles with the use of “AATCC Standard Detergent 1993”. The home laundering procedure was done according to MTCC Test Method 124-1996 (“Appearance of Fabrics After Repeated Home Laundering”). The water temperature for laundering was approximately 46° C.

Fabric Performance Evaluation

The limiting oxygen index (LOI) of the cotton fabric was measured according to ASTM Standard Method D2863-00. The tensile strength of the fabric was measured according to ASTM Standard Method D5035-95.

Determination of Phosphorus Concentration on the Treated Cotton Fabric

Approximately 2 g of treated cotton fabric taken from different parts of a larger fabric specimen was ground in a Wiley mill into powder to improve sample uniformity. Then, 2 ml of concentrated H₂SO₄ was added to 0.1 g of cotton powder. Ten milliliters of 30% H₂O₂was added dropwise to the mixture, allowing the reaction to subside between drops. The reaction mixture was then heated at approximately 250° C. to digest the powder and to evaporate the water until dense SO₃ vapor is produced. The completely digested cotton sample as a clear solution was transferred to a 50-ml volumetric flask, then diluted with distilled/deionized water. The sample thus prepared was analyzed with a Thermo-Farrell-Ash Model 965 inductively coupled plasma atomic emission spectrometer (ICP/AES) to determine the phosphorus content. The percent phosphorus retention of the treated fabric after home laundering was calculated using the formula (P_{AL}/P_{BW}) 100%, where P_{AL} and P_{BW} are the phosphorus contents on the fabric after laundering and that before washing, respectively.

Results and Discussion

The Flame Retarding System and the Factorial Experimental Design Method

DMDHEU has four hemiacetal groups to react with the hydroxyl groups of cellulose (Scheme II). The two hemiacetal groups derived from formaldehyde are significantly more reactive than those derived from glyoxal. Although Applicant does not wish to be bound by theory, in the presence of FR, these two hemiacetal groups are able to react with both hydroxyl groups of cotton cellulose and those of FR, thus forming covalent bonds between FR and cotton as shown in Scheme IV.

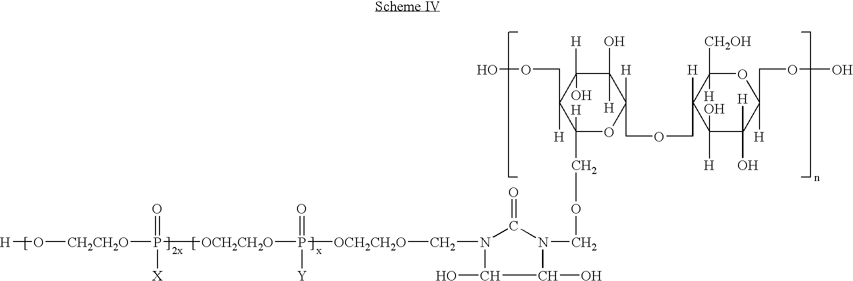

The TMM resin used in this study is a trifunctional reagent. When FR is present on the cotton fabric, TMM's hemiacetal groups react with the hydroxyl groups for cotton and FR, and form a linkage between cotton cellulose and FR (Scheme V).

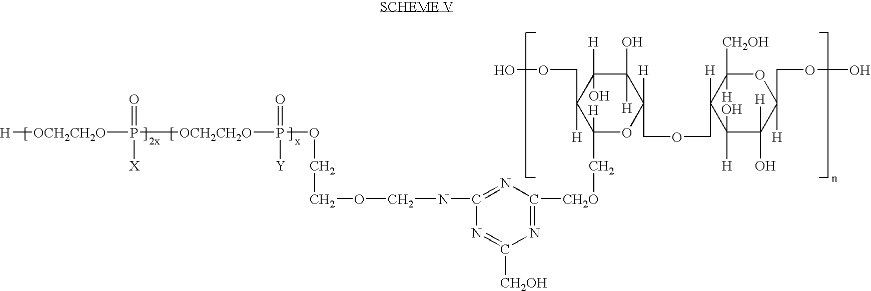

Both DMDHEU and TMM function as the binders for the flame retarding system. However, they have different reactivity, and the linkages between FR and cotton formed by the two binders have different durability to multiple laundering cycles. In this study, a two-factor factorial experimental design method was applied to study how an FR/DMDHEU/TMM formula influences the performance of the treated cotton fabric. The two factors used in this study, i.e., the FR concentration at three levels and the DMDHEU/(DMDHEU+TMM) ratio at five levels, are presented in Table 12. The performance of the treated cotton fabric was evaluated based on (1) phosphorus content on the fabric (%) and percent phosphorus retention by the fabric after home laundering and tumble dry (HLTD); (2) LOI of the cotton fabric before wash and after laundering; and (3) the tensile strength of the treated fabric at the filling direction after one laundering cycle. Duplicated tests were performed for each testing procedure.

The mathematical model used in the statistical analysis has a general polynomial form as shown in Eq. (1), where Yijk is the response variable, μ is the overall mean, αᵢ is the effect of the ith level of DMDHEU/(DMDHEU+TMM) ratio, βⱼ is the effect of the jth level of FR concentration (αβ)ᵢⱼ is the effect of the ith level of DMDHEU/(DMDHEU+TMM) ratio combined with the jth level of FR concentration (the interaction term), and εᵢⱼₖ is the residual error term.
yᵢⱼₖ=μ+αᵢ+βⱼ+(αβ)ᵢⱼ+εᵢⱼₖ (1)

The SAS® program was used in the statistical analysis to process the data. The statistical analysis was performed in the form of “analysis of variance” (ANOVA). This analysis included the F-test (overall model significance) and its associated probability (p-value) for studying the most influential factor affecting the performance of the treated cotton fabric. The F-test for interaction on phosphorus content, LOI, and tensile strength shows that there is no interaction between FR concentration and DMDHEU/(DMDHEU+TMM) ratio, therefore, the analysis of the effect of the DMDHEU/(DMDHEU+TMM) ratio and FR concentration on phosphorus content, LOI, and tensile strength is meaningful.

Effect of the DMDHEU/(DMDHEU+TMM) Ratio on the Phosphorus Content and Percent Phosphorus Retention

The cotton fabric was treated with FR at three concentration levels (16%, 32%, and 48%) combined with 7% (DMDHEU+TMM) at five different DMDHEU/(DMDHEU+TMM) ratios, then cured at 165° C. for 2.5 min. The phosphorus concentration (%) of the cotton fabric thus treated before wash and after 1, 10, 25, and 50 laundering cycles is shown in Table 13, which includes the results of the two replicated sets of testing.

The statistical analysis on the phosphorus content data of the treated fabric after different number of home laundering cycles is presented in Table 14. The data show that the p-value is 0.3436 before wash, which is higher than the significance level (α=0.05), meaning that the DMDHEU/(DMDHEU+TMM) ratio has no effect on the phosphorus content on the treated cotton fabric before wash. This is because all the formulas contain the same FR concentration at each DMDHEU/(DMDHEU+TMM) level, therefore the phosphorus concentration on the fabric before wash is not related to the ratio of the two binders in those formulas. The p-value decreases to 0.0171 after one laundering cycle, which is smaller than the significance level (α=0.05). Therefore, the null hypothesis can be rejected and it is concluded that the DMDHEU/(DMDHEU+TMM) ratio has a significant effect on the phosphorus content on treated fabric after laundering. An increase in the DMDHEU content in the (DMDHEU+TMM) mixture evidently increases the percent phosphorus retention of the fabric after one laundering cycle as shown in Table 13. In our previous research, it was found that DMDHEU is a more efficient reagent than TMM to bind FR to cotton, therefore an increase in DMDHEU/(DMDHEU+TMM) ratio results in increasing the amount of FR bound to the fabric.

The p-value decreases from 0.0171 after one laundering cycle to 0.0040 after 10 laundering cycles. Thus, the data indicate that the effects on the phosphorus content by varying the DMDHEU/(DMDHEU+TMM) ratio become more profound as the number of the home laundering cycle increases. The fabric treated using a formula with higher DMDHEU content has higher laundering durability. The p-values after 25 and 50 laundering cycles are 0.0053 and 0.0045, respectively, which are all very close to that after 10 launderings.

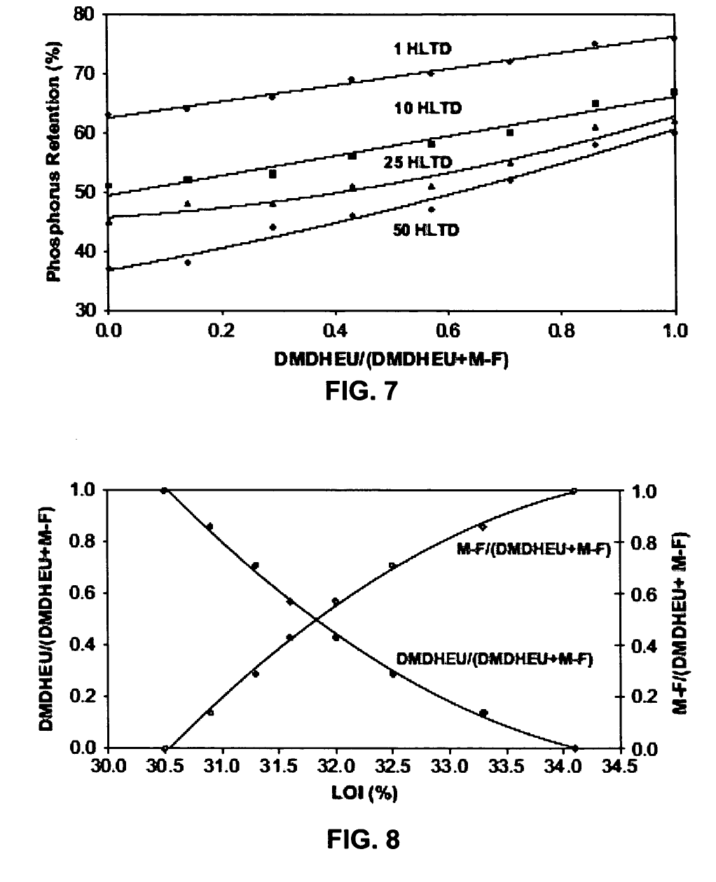

To illustrate the effect of varying the DMDMDH/(DMDHDU+TMM) ratio on the phosphorus retention and the laundering durability of the treated fabric, the percent phosphorus retention of the cotton fabric treated with 32% FR in combination with 7% (DMDHEU+TMM) after different numbers of home laundering cycles was plotted against the DMDHEU/(DMDHEU+TMM) ratio in FIG. 7. The fabric treated with 32% FR and 7% TMM [DMDHEU/(DMDHEU+TMM)=0] retained 63% of the phosphorus after one laundering cycle. When the fabric is treated using 7% DMDHEU [DMDHEU/(DMDHEU+TMM)=1], the phosphorus retention increases to 80%. After 50 laundering cycles, the phosphorus retention of the fabric treated with 7% TMM is 37%, whereas it increases to 62% for the fabric treated with 7% DMDHEU. The effect of varying the DMDHEU/(DMDHEU+TMM) ratio on the phosphorus retention becomes more significant as the number of laundering cycle increases, thus indicating the bonding formed by DMDHEU between FR and cotton is more durable to the laundering that that formed by TMM.

The data presented here also show that the dependency of the phosphorus content on the DMDHEU/(DMDHEU+TMM) ratio is also affected by the FR concentration. At 16% FR, the phosphorus content on the fabric after one laundering cycle increases only slightly from 1.90 to 1.95% and the phosphorus retention remains 79% as the DMDHEU/(DMDHEU+TMM) ratio is increased from 0/7 to 7/7 (Table 13). When the FR concentration is increased to 32%, the phosphorus content increases from 2.89 to 3.54% and the phosphorus retention increases from 62 to 79% in the same DMDHEU/(DMDHEU+TMM) ratio range (Table 13). Evidently, the effect of varying the DMDHEU/(DMDHEU+TMM) ratio on the phosphorus concentration after laundering becomes more significant as the FR concentration increases. At the relatively low FR concentration (16%), the number of hemiacetal groups of DMDHEU and TMM is far greater than the number of hydroxyl groups of FR, therefore most of the FR molecules form two covalent linkages with DMDHEU and TMM, thus improving their retention on the fabric after laundering. As a result, the percent phosphorus retention on the fabric after laundering is less sensitive to the DMDHEU/(DMDHEU+TMM) ratio. As the FR concentration is increased, the relative amount of FR forming two covalent bonds decreases, and consequently, the percent phosphorus retention after laundering has a significant dependency on the types of binder used, as shown in the data presented in Table 13.

Effect of DMDHEU/(DMDHEU+TMM) Ratio on the LOI

The LOI of the cotton fabric treated FR at the three concentration levels combined with (DMDHEU+TMM) at five different DMDHEU/(DMDHEU+TMM) ratios before wash and after 1, 10, 25 and 50 laundering cycles is shown in Table 15. The two-factorial experimental design method was used to analyze the effect of the DMDHEU/(DMDHEU+TMM) ratio on the LOI of the treated cotton fabric after different number of laundering cycles (Table 16). The p-value is <0.0001 for the treated fabric before wash (Table 16). This indicates that the DMDHEU/(DMDHEU+TMM) ratio has a profound effect on the flame retarding performance of the treated fabric before wash. All the FR/(DMDHEU+TMM) finish solutions used to treat the cotton fabric in this study contain the same FR concentrations (32%) and the same total concentration of DMDHEU and TMM (7%). The significantly higher LOI values of the fabric treated with the same concentrations of FR and (DMDHEU+TMM) but smaller DMDHEU/(DMDHEU+TMM) ratios [larger TMM/(DMDHEU+TMM) ratios] are attributed to the different effectiveness of DMDHEU and TMM in enhancing the performance of this flame retarding system. Both DMDHEU and TMM function as nitrogen providers to enhance the flame retarding performance due to phosphorus-nitrogen synergism. However, TMM provides a higher level of phosphorus nitrogen synergism than DMDHEU. Consequently, the fabric treated with a lower DMDHEU/(DMDHEU+TMM) ratio [higher TMM/(DMDHEU+TMM) ratio] demonstrates a higher LOI as shown in FIG. 8.

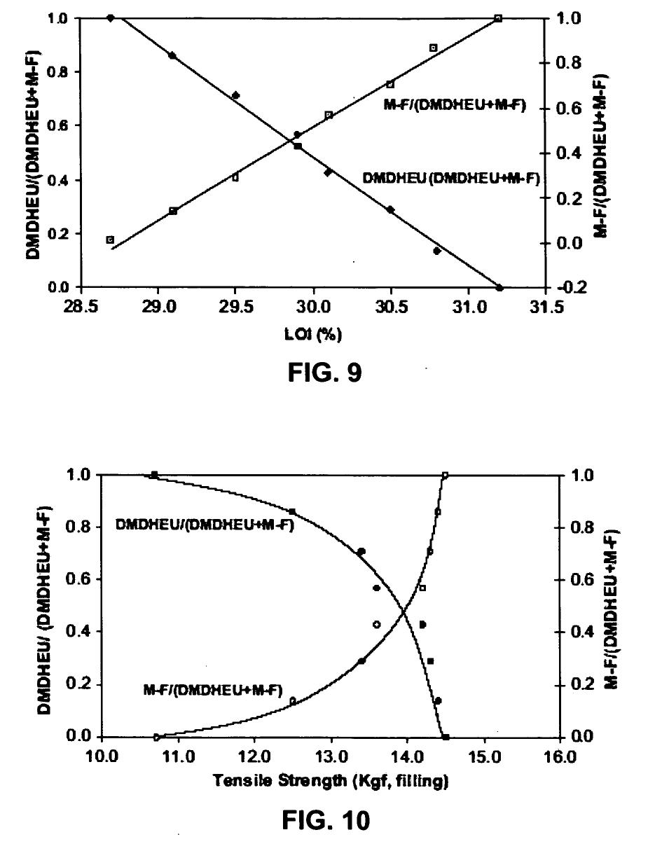

The p-value for the treated fabric is still less than 0.0001 after 1 and 10 laundering cycles. The p-values after 25 and 50 laundering cycles are 0.0026 and 0.0003, respectively. Since all the p-values are less than significance level at a =0.05, the null hypothesis can be rejected and it is concluded that the DMDHEU/(DMDHEU+TMM) ratio has a significant effect on the LOI of the treated cotton fabric after multiple laundering cycles. The correlation between the LOI and the ratios of DMDHEU/(DMDHEU+TMM) and TMM/(DMDHEU+TMM) of the treated cotton fabric after 25 laundering cycles is illustrated in FIG. 9. As discussed above, DMDHEU is a more effective binder for FR. Increasing the DMDHEU/(DMDHEU+TMM) ratio increases the amount of FR bound to cotton and also increases the laundering durability of FR on cotton. The lower LOI values for the fabric treated with higher DMDHEU/(DMDHEU+TMM) ratios after multiple laundering cycles indicate that the effect of reduced phosphorus nitrogen synergism due to the increasing quantity of DMDHEU in the (DMDHEU+TMM) mixture outweighs that of improved bonding of FR to cotton and improved laundering durability of FR on cotton. The synergism provided by DMDHEU and TMM appears to be the predominant factor in influencing the flame retarding performance of the FR/(DMDHEU+TMM) system.

Effect of the DMDHEU/(DMDHEU+TMM) Ratio on the Tensile Strength

The tensile strength at the filling direction of the cotton fabric treated with FR at three concentrations and (DMDHEU+TMM) at five different ratios and the statistical analysis of the fabric tensile strength data are shown in Tables 17 and 18, respectively. The p-value is 0.0002, far less than significant level at α=0.05 (Table 17). Thus, it is concluded that the tensile strength of the treated cotton fabric is also significantly affected by the DMDHEU/(DMDHEU+TMM) ratio. At the 32% FR level, the fabric tensile strength decreases from 14.5 to 10.7 kg as the DMDHEU/(DMDHEU+TMM) ratio increases from 0/7 to 7/7 (Table 17).

In previous research on the cotton fabric treated with DMDHEU, it was found that the fabric strength loss is due to cellulose depolymerization caused by the catalyst and the crosslinking of cellulose molecules. Since all the FR/(DMDHEU+TMM) solutions used to treat the fabric contain the same catalyst concentration (0.5%), the fabric strength loss attributed to cellulose depolymerization should be independent of the DMDHEU/(DMDHEU+TMM) ratio. It was also found that DMDHEU is a more efficient crosslinking agent for cotton than TMM. Therefore, the increase in the fabric strength loss as a result of a higher DMDHEU/(DMDHEU+TMM) ratio at all three FR concentrations shown in Table 17 is attributed to the increase in the amount of crosslinking formed on the fabric. The tensile strength of the cotton fabric is plotted against the ratios of DMDHEU/(DMDHEU+TMM) and TMM/(DMDHEU+TMM) in FIG. 10. The data presented here clearly demonstrate the dependency of the tensile strength of the treated fabric on the ratios of the two binders (Table 18).

Effect of the FR Concentrations on the Phosphorus Content, LOI and Tensile Strength

The statistical analysis of the phosphorus content, LOI and tensile strength affected by the FR concentration is shown in Table 19. The p-values for phosphorus content, LOI and tensile strength after different number of laundering cycles are all well below the significance level (α=0.05). Thus, the FR concentrations have a statistically significant effect on all the parameters of the treated fabric.

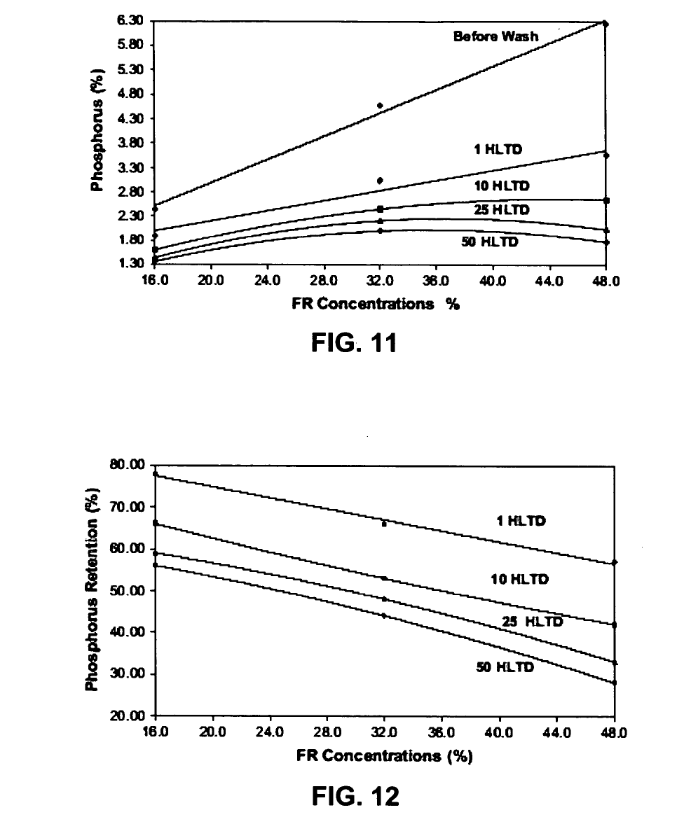

The cotton fabric was treated with FR at three concentration levels and 7% (DMDHEU+TMM) with a 0.29 (2/7) DMDHEU/(DMDHEU+TMM) ratio. The phosphorus content and percent phosphorus retention of the treated fabric after 1,10, 25, and 50 laundering cycles are presented in FIGS. 11 and 12, respectively. One observes that the phosphorus content on the treated fabric after different numbers of laundering cycles increases as the FR concentration increases (FIG. 11). However, the data presented here also clearly demonstrate that the percent phosphorus retention decreases as the FR concentration increases (FIG. 12). The percent phosphorus retention decreases from 78 to 57% (a 28% decline) as the FR concentration increases from 16 to 48% after one laundering cycle, and it decreases from 56% to 28% (a 50% decline) in the same FR concentration range after 50 laundering cycles (FIG. 12). The data presented in FIG. 12 show that the effect of the FR concentration on the percent phosphorus retention on the fabric becomes more profound as the number of laundering cycles increases. When the amount of FR relative to that of (DMDHEU+TMM) becomes high, the number of the hemiacetal groups of DMDHEU and TMM may be inadequate for bonding FR to cotton, thus reducing the percent phosphorus retention on the fabric as shown in FIG. 12. At a relatively low FR/(DMDHEU+TMM) ratio, both hydroxyl groups of an FR molecule may be able to react with the binders, and thus being bound to cotton with two covalent bonds. Consequently, the laundering durability of the FR thus bound to cotton is improved. As the FR/(DMDHEU+TMM) ratio increases, more FR is bound to cotton by single linkage, thus reducing its laundering durability.

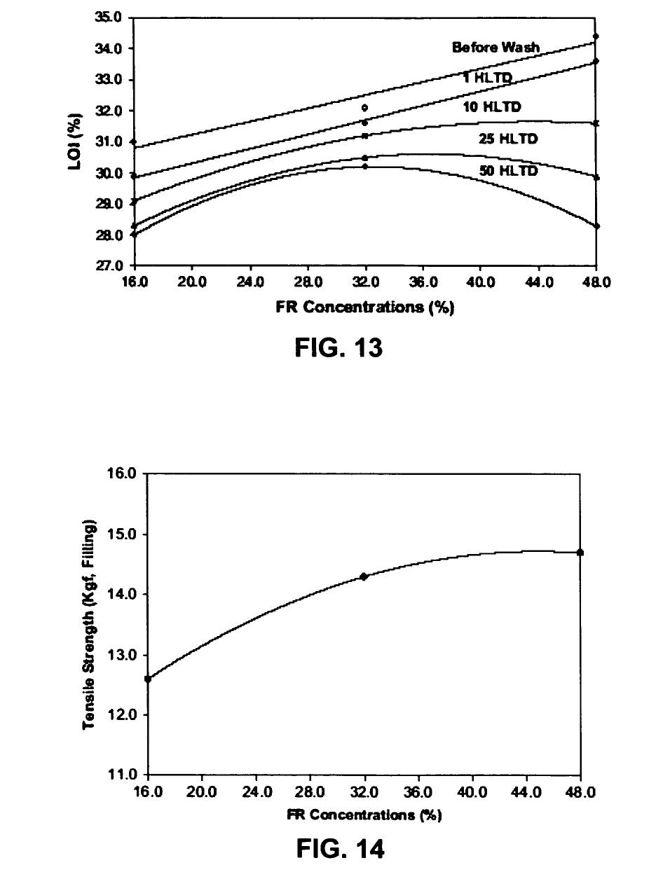

The LOI of the cotton fabric treated with FR and 7% (DMDHEU+TMM) with a DMDHEU/(DMDHEU+TMM) ratio of 0.29 (2/7) is plotted against the concentration in FIG. 13. The LOI of the treated fabric before wash and after one wash increases as the FR concentration increases (FIG. 13). When the number of laundering cycle increases to 25 and 50 cycles, however, the LOI of the treated fabric increases from 28.3 and 28.0 at the 16% FR concentration level to 30.5 and 30.2 at the 32% FR concentration level, and then decreases to 29.9/28.3, respectively, at the 48% FR concentration level (FIG. 13). The data shown here are another indication of the reduced laundering durability of the treated fabric at exceedingly high FR/(DMDHEU+TMM) ratio.

Presented in FIG. 14 is the tensile strength of the cotton fabric treated with FR and 7% (DMDHEU+TMM) as a function of FR concentrations. The fabric strength at the filling direction increases from 12.6 to 14.7 kg as the FR concentration increases from 16 to 48%. As discussed above, the hydroxyl groups of cellulose and those of FR compete to react with the binders. More DMDHEU and TMM form crosslinking on the cotton fabric as the FR concentration decreases, thus causing more fabric loss due to the increasing amount of crosslinking.

When a group of substituents is disclosed herein, it is intended that all individual members of those groups and all subgroups, including any isomers and enantiomers of the group members, and classes of compounds that can be formed using the substituents are disclosed separately. When a system is claimed, it should be understood that systems known in the art including the systems disclosed in the references disclosed herein are not intended to be included. When a Markush group or other grouping is used herein, all individual members of the group and all combinations and subcombinations possible of the group are intended to be individually included in the disclosure.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, additives, starting materials, and synthetic methods other than those specifically exemplified can be employed in the practice of the invention without resort to undue experimentation. All art-known functional equivalents of any such methods, additives, starting materials, and synthetic methods intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein. Art-known additives such as softeners, dyes, wrinkle-resist agents, de-foaming agents, buffers, pH stabilizers, fixing agents, stain repellents, stain blocking agents, soil repellents, wetting agents, water repellents, stain release agents, optical brighteners, emulsifiers and surfactants may be added to the formulas described herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. All patents and publications mentioned in the specification are indicative of the levels of skill of those skilled in the art to which the invention pertains.

One skilled in the art would readily appreciate that the present invention is well adapted to carry out the objects and obtain the ends and advantages mentioned, as well as those inherent therein. The systems and methods and accessory methods described herein as presently representative of preferred embodiments are exemplary and are not intended as limitations on the scope of the invention. Changes therein and other uses will occur to those skilled in the art, which are encompassed within the spirit of the invention, are defined by the scope of the claims.

Although the description herein contains many specificities, these should not be construed as limiting the scope of the invention, but as merely providing illustrations of some of the embodiments of the invention. Thus, additional embodiments are within the scope of the invention and within the exemplary claims. All references provided herein are incorporated by reference to the extent not inconsistent with the disclosure herein. Some references are incorporated by reference herein to provide details concerning additional starting materials, additional methods of synthesis, additional methods of analysis and additional uses of the invention.

### REFERENCES

1. Lewin M. In: Lewin, M., Sello S. B (ed.), Handbook of Fiber Science and Technology: Vol. 11. Part A, Mercel Dekker, New York, 1984, p.117-120.
2. Horrocks A R. Rev. Prog. Coloration 1986;16:62-101.
3. Horrocks A R. In: Heywood, D., editor, Textile Finishing, Society of Dyers and Colourists, West Yorkshore, U.K., 2003, p.214-250.
4. Levchik S V, Weil E D. Polym. International 2000; 49:1033-1073.
5. Weil E D, Levchik S V. Fire Science, 2004; 24:251264.
6. Busch C W. U.S. Pat. No. 3,639,232 (1972).
7. Nemes J J, Polansky R, Herbes W F. U.S. Pat. No. 3,308,098 (1967).
8. Bryan, R J. U.S. Pat. No. 3,637,552 (1972).
9. Bumell, M R. U.S. Pat. No. 2,953,480 (1960).
10. Lewin M. Polym Adv Tech 2002; 13:1091-1102.
11. John, H H. U.S. Pat. No. 4,812,144 (1989).
12. Hauser, P J. U.S. Pat. No. 4,732,789 (1988).
13. Fleming, G R, Green, J R. U.S. Pat. No. 5,468,545 (1995).
14. Hansen, J H. U.S. Pat. No. 4,750,911, (1988).
15. Fleming, G R., Green, J. R., U.S. Pat. No. 5,480,458 (1996).
16. Cole, R., U.S. Pat. No. 5,942,006 (1999).
17. Yang C Q, Wu W. Fire and Materials, 2003; 29:223-237.
18. Yang C Q, Wu W. Fire and Materials, 2003; 29:239-251.
19. Wu W, Yang C Q. Fire Sciences, 2004; 22:11-23.
20. Wu W, Yang C Q. Polym. Degrad. Stab., 2004; 85: 623-632.
21. Yang C Q, Wu W. Fire and Materials, in press.
22. Homsby P R, Wang J, Rothon R. Polym. Degrad. Stab 1996; 51: 235-249.
23. Levchik S V, Weil E D. Polym. International 1999; 48:532-557.
24. Horrocks A R, Zhang S. Char formation in polyamide (nylon 6 and nylon 6.6) and wool keratin phosphorylated by polyol chlorides. Textile Res. J 2004; 74:433.
Charles Q. Yang and Guozhong Xu, “Polymer-Aldehyde Additives to Improve paper Properties”, U.S. Pat. No. 6,379,499, Oct. 30, 2001.
Charles Q. Yang, “Crosslinking Agents of Cellulosic Fabrics”, U.S. Pat. No. 6,165,919, Dec. 26, 2000.
C. Q. Yang, W. Wu, J. K. Stowell, E. D. Weil, “A Durable Flame Retardant Finish of Cellulosic Materials”, PCT International Publication Number WO 2004/001121 A2, Dec. 31, 2003.
Stowell et al., U.S. Pat. No. 6,309,565, issued Oct. 30, 2001.
Yang et al., U.S. Published Patent application 2005/0272838 A1, published Dec. 8, 2005.
Yang et al., MTCC International Conference, Sep. 13-17, 2004, pp. 87-99.
Yang et al., Fifteenth Annual BCC Conference on Flame Retardancy, June 2004, pp. 239-251.
Yang et al., International Publication No. WO 03/072871 A1, published Sep. 4, 2003.
Yang et al., International Publication No. WO 2004/001121 A1, published Dec. 31, 2003.
Weil et al., U.S. Pat. No. 3,746,572, issued Jul. 17, 1973.
Stowell et al., U.S. Pat. No. 6,365,070, issued Apr. 2, 2002.

Yang et al., 2^{nd} International Textile, Clothing & Design Conference, Dubrovnik, Croatia, Oct. 3-6, 2004, pp. 480-489.

TABLE 1
Phosphorus content (%) and phosphorus retention of the
nylon-6,6 fabric treated with 40% FR, 6% DMDHEU and
6% TMM, cured at 165° C. for 2 min and subjected
to different number of laundering cycles.

| Number of | Phosphorus | |
|---|---|---|
| Laundering Cycles | Concentration (%) | Phosphorus Retention (%) |
| Before Laundering | 3.63 | — |
| 1 | 1.52 | 42 |
| 3 | 1.50 | 41 |

TABLE 2
Phosphorus content (%) and phosphorus retention of the
nylon-6 fabric treated with 40% FR, 6% DMDHEU
and 6% TMM, cured at 165° C. for 2 min and subjected
to different number of laundering cycles.

| Number of | Phosphorus | |
|---|---|---|
| Laundering Cycles | Concentration (%) | Phosphorus Retention (%) |
| Before Laundering | 6.51 | — |
| 1 | 2.72 | 42 |
| 3 | 2.72 | 42 |

TABLE 3
The DTG peak, DSC peak and the TG total weight loss
of the untreated nylon-6 fabric and the nylon-6 fabric
treated with 40% FR, 6% DMDHEU and 6% TMM
and cured at 165° C. for 2 min.

| | | DSC | TG |
|---|---|---|---|
| | DTG | Endothermal | Weight Loss |
| Sample Description | Peak (° C.) | Peak (° C.) | at 500° C. (%) |
| Untreated Nylon-6 Fabric | 424 | 425 | 90 |
| Treated Nylon-6 Fabric | 343 | 342 | 77 |
| before Laundering | | | |
| Treated Nylon-6 Fabric | 395 | 397 | 85 |
| Subjected to 3 Laundering | | | |
| Cycles | | | |

TABLE 4
The Formulas (A1-A2) used for the treatment of cotton/nylon
blend fabric

| | | | | | | Wetting | Wet |
|---|---|---|---|---|---|---|---|
| Sample | FR | DMDHEU | XMM | TMM | Catalyst | Agent | Pick-up |
| Code | (%) | (%) | (%) | (%) | (%) | (%) | (%) |
| A1 | 40 | 3.5 | — | 4.8 | 0.2 | 0.2 | 78 |
| A2 | 40 | — | 3.4 | 4.8 | 0.2 | 0.2 | 80 |

TABLE 5
The char length (cm) of the cotton/nylon blend treated 40% FR and
different bonding system components and cured at 165° C. for 2 min

| | | Number of Home Laundering Cycles | | | | | |
|---|---|---|---|---|---|---|---|
| Sample | | Before | | | | | |
| Code | Bonding System | Wash | 1 | 5 | 10 | 20 | 40 |
| A1 | 3.5% DMDHEU, | 5.2 | 7.5 | 8.0 | 7.8 | 10 | 8.8 |
| | 4.8% TMM | | | | | | |
| A2 | 3.4% XMM, 4.8% TMM | 6.2 | 8.6 | 6.3 | 10.2 | 6.9 | 8.5 |

TABLE 6
The Formulas (B1-B2) used for the treatment of cotton/nylon
blend fabric.

| Sample | FR | XMM | TMM | Catalyst | Wetting Agent | Wet Pick-up |
|---|---|---|---|---|---|---|
| Code | (%) | (%) | (%) | (%) | (%) | (%) |
| B1 | 40 | 3.4 | 2.6 | 0.2 | 0.2 | 78 |
| B2 | 32 | 3.4 | 5.1 | 0.2 | 0.2 | 77 |

TABLE 7
The phosphorus concentration (%) of the cotton/nylon blend treated
with the Formulas B1-B2 and cured at 165° C. for 2 min.

| | | Number of Home Laundering Cycles | | | | | |
|---|---|---|---|---|---|---|---|
| Sample | FR Concentration | Before | | | | | |
| Code | (%) | Wash | 1 | 10 | 20 | 40 | 50 |
| B1 | 40 | 3.79 | 2.26 | 1.15 | 1.28 | 0.96 | — |
| B2 | 32 | 3.09 | 2.17 | 1.91 | 1.89 | 1.50 | 1.43 |

TABLE 8
The LOI (%) of the cotton/nylon blend treated with the Formulas
B1-B2 and cured at 165° C. for 2 min.

| | | Number of Home Laundering Cycles | | | | | |
|---|---|---|---|---|---|---|---|
| Sample | FR Concentration | Before | | | | | |
| Code | (%) | Wash | 1 | 10 | 20 | 40 | 50 |
| B1 | 40 | 29.3 | 28.4 | 27.2 | 26.1 | 24.5 | — |
| B2 | 32 | 29.5 | 28.6 | 28.0 | 28.1 | 26.9 | 26.0 |

TABLE 9
The char length (cm) of the cotton/nylon blend treated with Formulas
B1-B2 and cured at 165° C. for 2 min.

| | | Number of Home Laundering Cycles | | | | | |
|---|---|---|---|---|---|---|---|
| Sample | FR Concentration | Before | | | | | |
| Code | (%) | Wash | 1 | 10 | 20 | 40 | 50 |
| B1 | 40 | 5.0 | 8.4 | 7.8 | 5.8 | >30 | >30 |
| B2 | 32 | 5.8 | 6.5 | 9.3 | 6.8 | 8.2 | 9.6 |

TABLE 10
The LOI (%) of the Nomex/Cotton blend fabric treated with the
FR/BTCA system and cured at 165° C. for 2 min.

| | | | NUMBER OF HOME | | | | |
|---|---|---|---|---|---|---|---|
| FR | BTCA | H₃PO₂T/ | LAUNDERING CYCLES | | | | |
| (%) | (%) | TEA % | 1 | 5 | 10 | 15 | 20 |
| 12 | 4 | 2.4/3.0 | 33.8 | 30.0 | 28.9 | 28.0 | 27.6 |
| 18 | 6 | 3.6/4.5 | 36.1 | 33.0 | 31.7 | 30.8 | 29.9 |
| 24 | 8 | 4.8/6.0 | 37.7 | 34.3 | 32.9 | 31.2 | 30.9 |

| | |
|---|---|
| Control | 21.8 |

TABLE 11
The char length (mm) of the Nomex/Cotton blend fabric treated
with the FR/BTCA system and cured at 165° C. for 2 min.

| | | | NUMBER OF HOME | | | | |
|---|---|---|---|---|---|---|---|
| | | | LAUNDERING CYCLES | | | | |
| FR (%) | BTCA (%) | H₃PO₂T/TEA % | 1 | 5 | 10 | 15 | 20 |
| 12 | 4 | 2.4/3.0 | 32 | 34 | 46 | 61 | 67 |
| 18 | 6 | 3.6/4.5 | 33 | 35 | 34 | 51 | 56 |
| 24 | 8 | 4.8/6.0 | 32 | 35 | 25 | 45 | 40 |

| | |
|---|---|
| Control | >300 |

TABLE 12
The factors and levels of a two-factorial experimental design method.

| | Levels | | | | |
|---|---|---|---|---|---|
| Factors | 1 | 2 | 3 | 4 | 5 |
| A: DMDHEU/ | 0.00 | 0.29 | 0.57 | 0.86 | 1.00 |
| (DHDHEU + TMM) ratios | (0/7) | (2/7) | (4/7) | (6/7) | (7/7) |
| B: FR concentrations (%) | 16 | 32 | 48 | — | — |

TABLE 13
The phosphorus content of the cotton fabric treated with FR (16%, 32%, and 48% combined with 7%
(DMDHEU + M − F) at five different DMDHEU/(DMDHEU + M − F) ratios (two duplicated testing results).

| | Factor B | | | | | | | | | | | | | | |
|---|---|---|---|---|---|---|---|---|---|---|---|---|---|---|---|
| Fac- | 16% | | | | | 32% | | | | | 48% | | | | |
| tor | Before | 1 | 10 | 25 | 50 | Before | 1 | 10 | 25 | 50 | Before | 1 | 10 | 25 | 50 |
| A | Wash | HLTD | HLTD | HLTD | HLTD | Wash | HLTD | HLTD | HLTD | HLTD | Wash | HLTD | HLTD | HLTD | HLTD |
| 0.00 | 2.41 | 1.90 | 1.59 | 1.43 | 1.41 | 4.55 | 2.88 | 2.30 | 2.04 | 1.70 | 6.28 | 3.30 | 2.61 | 2.03 | 1.58 |
| (0/7) | 2.38 | 1.89 | 1.58 | 1.42 | 1.38 | 4.58 | 2.86 | 2.28 | 2.26 | 1.68 | 6.28 | 3.28 | 2.58 | 2.00 | 1.60 |
| 0.29 | 2.43 | 1.92 | 1.60 | 1.44 | 1.34 | 4.58 | 3.03 | 2.45 | 2.21 | 2.00 | 6.24 | 3.56 | 2.65 | 2.03 | 1.77 |
| (2/7) | 2.42 | 1.93 | 1.61 | 1.45 | 1.36 | 4.56 | 3.00 | 2.48 | 2.18 | 2.02 | 6.26 | 3.58 | 2.68 | 2.06 | 1.80 |
| 0.57 | 2.39 | 1.97 | 1.66 | 1.48 | 1.32 | 4.53 | 3.15 | 2.63 | 2.33 | 2.12 | 6.30 | 3.96 | 3.14 | 2.41 | 1.79 |
| (4/7) | 2.36 | 1.96 | 1.68 | 1.50 | 1.36 | 4.56 | 3.16 | 2.61 | 2.36 | 2.10 | 3.29 | 4.00 | 3.10 | 2.38 | 1.80 |
| 0.86 | 2.38 | 1.92 | 1.70 | 1.54 | 1.53 | 4.47 | 3.43 | 2.99 | 2.80 | 2.66 | 6.27 | 4.43 | 3.47 | 2.95 | 2.27 |
| (6/7) | 2.36 | 1.90 | 1.69 | 1.58 | 1.56 | 4.50 | 3.40 | 2.98 | 2.80 | 2.68 | 6.28 | 4.45 | 3.50 | 2.98 | 2.28 |
| 1.00 | 2.44 | 1.95 | 1.79 | 1.63 | 1.47 | 4.42 | 3.52 | 3.06 | 2.82 | 2.75 | 6.27 | 4.58 | 3.73 | 3.15 | 2.53 |
| (7/7) | 2.48 | 1.96 | 1.81 | 1.66 | 1.50 | 4.48 | 3.55 | 3.08 | 2.85 | 2.78 | 6.27 | 4.56 | 3.69 | 3.18 | 2.58 |

TABLE 14
The statistical analysis of the effect of DMDHEU/(DMDHEU + M − F)
ratio on the phosphorus content of the treated cotton fabric.

| Laundering | Sum | Mean Square | | |
|---|---|---|---|---|
| Conditions | Square of Error | of Error | F-Value | p > F-Value |
| Before Wash | 0.002 | 0.002 | 1.01 | 0.3436 |
| After 1 HLTD | 0.65 | 0.65 | 9.00 | 0.0171 |
| After 10 HLTD | 0.72 | 0.72 | 15.95 | 0.0040 |
| After 25 HLTD | 0.73 | 0.73 | 14.40 | 0.0053 |
| After 50 HLTD | 0.71 | 0.71 | 15.21 | 0.0045 |

TABLE 15
The LOI of the cotton fabric treated with FR (16%, 32%, and 48%) combined with 7% (DMDHEU + M − F) at five
different DMDHEU/(DMDHEU + M − F) ratios (two duplicated testing results).

| | Factor B | | | | | | | | | | | | | | |
|---|---|---|---|---|---|---|---|---|---|---|---|---|---|---|---|
| Fac- | 16% | | | | | 32% | | | | | 48% | | | | |
| tor | Before | 1 | 10 | 25 | 50 | Before | 1 | 10 | 25 | 50 | Before | 1 | 10 | 25 | 50 |
| A | Wash | HLTD | HLTD | HLTD | HLTD | Wash | HLTD | HLTD | HLTD | HLTD | Wash | HLTD | HLTD | HLTD | HLTD |
| 0.00 | 32.1 | 31.5 | 30.2 | 29.8 | 29.1 | 34.1 | 32.7 | 31.8 | 31.2 | 30.9 | 35.0 | 34.3 | 33.2 | 31.0 | 30.3 |
| (0/7) | 31.8 | 31.8 | 30.0 | 30.0 | 28.8 | 33.8 | 32.8 | 32.0 | 31.0 | 30.8 | 35.2 | 34.6 | 32.8 | 31.2 | 30.6 |
| 0.29 | 31.0 | 29.9 | 29.1 | 28.3 | 28.0 | 32.1 | 31.6 | 31.2 | 30.5 | 30.2 | 34.4 | 33.6 | 32.1 | 29.9 | 28.3 |
| (2/7) | 31.2 | 29.8 | 28.8 | 28.6 | 28.2 | 32.2 | 31.8 | 31.5 | 30.8 | 30.0 | 34.6 | 33.2 | 32.5 | 29.8 | 28.0 |
| 0.57 | 30.4 | 29.1 | 28.3 | 27.3 | 26.4 | 31.6 | 31.4 | 30.5 | 29.9 | 29.6 | 34.0 | 32.6 | 31.7 | 30.3 | 28.5 |
| (4/7) | 30.8 | 29.5 | 28.5 | 27.0 | 26.6 | 31.8 | 31.6 | 30.8 | 30.1 | 29.8 | 33.8 | 32.9 | 31.6 | 30.2 | 28.6 |
| 0.86 | 29.3 | 27.6 | 26.9 | 25.9 | 26.2 | 30.9 | 31.3 | 29.1 | 29.1 | 28.8 | 33.5 | 31.9 | 31.3 | 30.6 | 28.5 |
| (6/7) | 29.0 | 27.8 | 26.8 | 26.1 | 25.8 | 30.6 | 31.1 | 28.8 | 28.8 | 28.6 | 33.3 | 31.6 | 31.0 | 30.8 | 28.3 |
| 1.00 | 29.0 | 27.3 | 26.7 | 25.8 | 25.8 | 29.8 | 29.8 | 28.7 | 28.7 | 28.4 | 32.2 | 31.0 | 30.6 | 29.6 | 28.3 |
| (7/7) | 28.8 | 26.9 | 26.5 | 26.0 | 26.0 | 30.0 | 29.6 | 28.6 | 28.5 | 28.0 | 31.8 | 31.2 | 30.8 | 29.8 | 28.0 |

TABLE 16
The statistical analysis of the effect of DMDHEU/(DMDHEU + M − F)
ratio on the LOI of the treated cotton fabric.

| Laundering | Sum | Mean Square | | |
|---|---|---|---|---|
| Conditions | Square of Error | of Error | F-Value | p > F-Value |
| Before Wash | 17.34 | 17.34 | 111.51 | <0.0001 |
| After 1 HLTD | 18.03 | 18.03 | 86.81 | <0.0001 |
| After 10 HLTD | 14.11 | 14.11 | 119.72 | <0.0001 |
| After 25 HLTD | 10.40 | 10.40 | 18.62 | 0.0026 |
| After 50 HLTD | 10.14 | 10.14 | 37.23 | 0.0003 |

TABLE 17
The tensile strength of the cotton fabric treated
with FR (16%, 32%, and 48%) combined with 7%
(DMDHEU + M − F) at five different DMDHEU/(DMDHEU + M − F)
ratios (two duplicated testing results).

| | Factor B | | |
|---|---|---|---|
| Factor A | 16% | 32% | 48% |
| 0.00 (0/7) | 12.7/13.0 | 14.5/14.0 | 15.8/15.6 |
| 0.29 (2/7) | 12.6/12.2 | 14.3/13.8 | 14.7/15.0 |
| 0.57 (4/7) | 11.3/10.8 | 13.6/13.0 | 13.7/13.2 |
| 0.86 (6/7) | 11.2/10.6 | 12.5/12.3 | 12.4/12.0 |
| 1.00 (7/7) | 10.9/10.0 | 10.7/10.8 | 12.4/12.6 |

TABLE 18
The statistical analysis of the effect of DMDHEU/(DMDHEU + M − F)
ratio on the tensile strength of the treated cotton fabric.

| Wash | Sum | Mean | | |
|---|---|---|---|---|
| condition | square of error | square of error | F-value | p > F-value |
| After 1 HLTD | 13.5 | 13.5 | 38.9 | 0.0002 |

TABLE 19
The statistical analysis of effect of FR concentration on LOI, phosphorus content
and tensile strength of the treated cotton fabric.

| | P % | | | LOI (%) | | | Tensile strength (Kgf, filling) | | |
|---|---|---|---|---|---|---|---|---|---|
| | Sum | | | Sum | | | Sum | | |
| Wash | square of | | p > F- | square of | | p > F- | square of | | p > F- |
| condition | error | F-value | value | error | F-value | value | error | F-value | value |
| Before | 29.92 | 192.47 | <0.0001 | — | — | — | — | — | — |
| wash | | | | | | | | | |
| After 1 | 33.12 | 159.51 | <0.0001 | 10.34 | 10.34 | 10.34 | 10.61 | 30.57 | 0.0006 |
| HLTD | | | | | | | | | |
| After 10 | 31.32 | 265.88 | <0.0001 | 5.27 | 5.27 | 5.27 | — | — | — |
| HLTD | | | | | | | | | |
| After 25 | 20.45 | 36.31 | 0.0003 | 2.55 | 2.55 | 2.55 | — | — | — |
| HLTD | | | | | | | | | |
| After 50 | 7.06 | 25.91 | 0.0009 | 0.82 | 0.82 | 0.82 | — | — | — |
| HLTD | | | | | | | | | |

I claim:

1. A flame retardant system for nylon fabric comprising:
(a) an organophosphomus oligomer having two terminal hydroxy groups;
(b) a bonding system selected from the group consisting of:
(i) a condensation product of melamine and formaldehyde having at least 2 hemiacetal groups;
(ii) dimethyloldihydroxyethyleneurea (DMDHEU);
(iii) a mixture of DMDHEU and condensation product of melamine and formaldehyde with 2-6 hemiacetal groups from formaldehyde in its molecule; and
(iv) a polycarboxylic acid with at least three carboxyl groups in adjacent carbons of the back bone; and
(c) one or more optional catalysts.

2. The flame retardant system of claim 1, wherein the organophosphorous oligomer has the formula: 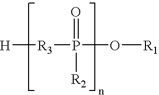
here R3 is independently selected from the group consisting of: —O— and 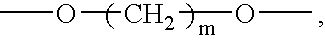
where m is an integer from 1 to 6; n is an integer from 1 to 10; R1 is H or a hydroxyalkyl group with from 1 to 6 carbon atoms; and R2 is independently selected from the group consisting of: alkyl, alkoxy and hydroxyalkoxy with from 1 to 6 carbon atoms.

3. The flame retardant system of claim 1, wherein the organophosphorous oligomer has the formula: 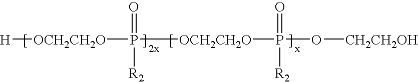
where x is a positive integer and R2 is independently selected from the group consisting of: alkyl, alkoxy and hydroxyalkoxy groups with from 1 to 6 carbon atoms.

4. The flame retardant system of claim 1, wherein the organophosphorous oligomer has the formula: 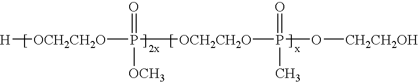
where x is a positive integer.

5. The flame retardant system of claim 1, wherein the catalyst is selected from the group consisting of: MgCl₂; a 10:1 to 20:1 w/w mixture of MgCl₂ and citric acid; NH₄Cl; phosphoric acid; phosphorous acid; and hypophosphorus acid; or a mixture of the catalysts listed above.

6. The flame retardant system of claim 1, wherein the fabric is selected from the group consisting of: nylon-6,6 and nylon-6.

7. The flame retardant system of claim 1, wherein the organophosphorous oligomer is present in the system at an amount between about 5-50% weight of fabric based on 100% solid.

8. The flame retardant system of claim 1, wherein the bonding system is present in the system between about 0.1-15% weight of fabric based on 100% solid.

9. The flame retardant system of claim 1, wherein the catalyst is present in the system between about 0.1-5% weight of fabric based on 100% solid.

10. A flame retardant system for Nomex/cotton blend fabric comprising:
(a) an organophosphorus oligomer having two terminal hydroxy groups;
(b) a polycarboxylic acid with at least three carboxyl groups in adjacent carbons of the back bone; and
(c) one or more optional catalysts.

11. A method of preparing flame retardant nylon fabric comprising: treating a nylon fabric with the composition of claim 1.

12. A flame retardant nylon fabric treated with the composition of claim 1.

13. A flame retardant nylon fabric containing a crosslinked polymeric network formed by a hydroxy-functional organophosphorus oligomer and bonding system.
